(19) United States
(12) Patent Application Publication
(10) Pub. No.: US 2015/0336335 A1
(43) Pub. Date: Nov. 26, 2015

(54) FIBER-REINFORCED COMPOSITE MATERIAL, METHOD OF PRODUCING SAME, AND ELEVATOR COMPONENT MEMBER AND ELEVATOR CAR THAT USE SAME

(71) Applicants: Tatsuya OKAWA, Chiyoda-ku, Tokyo (JP); Kazuki KUBO, (US); Yuhei AWANO, (US); Takahiro MABUCHI, (US); Sohei SAMEJIMA, (US); Michihito MATSUMOTO, (US)

(72) Inventors: Tatsuya OKAWA, Chiyoda-ku (JP); Kazuki KUBO, Chiyoda-ku (JP); Yuhei AWANO, Chiyoda-ku (JP); Takahiro MABUCHI, Chiyoda-ku (JP); Sohei SAMEJIMA, Chiyoda-ku (JP); Michichito MATSUMOTO, Chiyoda-ku (JP)

(73) Assignee: MITSUBISHI ELECTRIC CORPORATION, Chiyoda-ku (JP)

(21) Appl. No.: 14/654,922

(22) PCT Filed: Jan. 9, 2013
(86) PCT No.: PCT/JP2013/050232

§ 371 Date: Jun. 23, 2015

(51) Int. Cl. B29C 70/48; B66B 11/02; C08K 3/22; B32B 5/26; C08J 5/24; C08J 5/04; B29C 70/68; B32B 5/02

(52) U.S. Cl. CPC B29C 70/48; B29C 70/68; B66B 11/0226; B32B 5/024; B32B 5/26; C08J 5/24; C08J 5/042; C08K 3/22; C08K 3/2279; B29K 2067/00

(57) ABSTRACT

Provided is a method of producing a fiber-reinforced composite material, involving impregnating a fiber structure with a resin by using the pressure difference between a vacuum pressure and an atmospheric pressure and thereafter curing the resin, the method comprising: impregnating a mixture of a bromine-containing resin 22 and a powdered flame retardant 21 that contains at least one component selected from aluminum hydroxide and magnesium hydroxide and has an average particle size in the range of 0.1 to 20 μm into a fiber structure 10 that has a mode value for the size of fiber surrounded individual openings in the range of 0.03 to 3 mm² and an opening area percentage in the range of 0.1 to 10%, from a surface direction of the fiber structure 10, to unevenly distribute the powdered flame retardant 21 in a surface layer of the fiber structure 10. The present invention can simply and conveniently produce a highly flame-retardant and lightweight fiber-reinforced composite material that exhibits a high strength.

### TECHNICAL FIELD

The present invention relates to a fiber-reinforced composite material, a method of producing this fiber-reinforced composite material, and an elevator component member and an elevator car that use this fiber-reinforced composite material.

### BACKGROUND ART

Fiber-reinforced composite materials (fiber-reinforced plastics or FRPs) are characterized by lightweight and high strength. In particular, fiber-reinforced composite materials that combine glass fiber with a resin are used in numerous industrial sectors, e.g., for helmets, skis, racquets, bathtubs, building materials, materials for industrial electronic devices, small boats, and automobiles. In addition, since fiber-reinforced composite materials that use carbon fiber have even higher strengths, it is expected that they will find uses like weight-reducing substitute materials for metals such as iron and aluminum.

Flame retardancy is required when the fields of application for fiber-reinforced composite materials are broadened and they are used as building materials or component materials for consumer appliances and railroad cars. The benchmarks for flame retardancy include the “UL 94 standard” of the Underwriters Laboratories (UL) of the USA, which relates to electrical products in general; the “Flammability Standards for Materials for Railroad Cars”, also known as the Combustion Test Methods of the Japanese Ministry of Transport, which relate to railroad cars; and the Japanese Building Standard Law, which relates to building materials. The flame retardancy ratings established in the Japanese Building Standard Law are particularly stringent even when considered internationally.

In the sphere of electrical products, flame-retardant materials as established by the Japanese Building Standard Law must be used for the component materials of elevator cars. The cab and frame of elevator cars have heretofore been constructed of steel or an aluminum alloy; however, such elevator cars are not only heavy and thus require a large drive power, but also require a high degree of control during operation due to the large inertia. As a consequence, lightweight elevator cars have been introduced that use a sandwich panel structure in which the skin material is a fiber-reinforced composite material and the core material is a foam or that use a hollow-cross section panel structure in which the skin material and stringer are a fiber-reinforced composite material (refer, for example, to Patent Document 1).

Patent Document 1: Japanese Patent Application Laid-open No. 8-73157

### SUMMARY OF INVENTION

### Technical Problem

In addition to a lightweight and high strength, a high flame retardancy is also required of the fiber-reinforced composite materials used in, for example, consumer appliances, railroad cars, aircraft, and building-related products including elevator cars. However, such a fiber-reinforced composite material that is also equipped with a high flame retardancy has not been obtained to date. A fiber-reinforced composite material that achieves the flame retardancy ratings established in the Japanese Building Standard Law has not been obtained in particular.

The present invention has been made to solve the above problems, and an object of the present invention is to provide a lightweight, high-strength fiber-reinforced composite material that has a high flame retardancy. A further object of the present invention is to provide a method of producing this fiber-reinforced composite material.

### Solution to the Problem

The present invention is a method of producing a fiber-reinforced composite material, involving impregnating a fiber structure with a resin by using the pressure difference between a vacuum pressure and an atmospheric pressure and curing the resin, the method including impregnating a mixture of a bromine-containing resin and a powdered flame retardant that contains at least one component selected from aluminum hydroxide and magnesium hydroxide and has an average particle size in the range of 0.1 to 20 μm, into a fiber structure that has a mode value for the size of fiber-surrounded individual openings in the range of 0.03 to 3 mm² and an opening area percentage in the range of 0.1 to 10% from a surface direction of the fiber structure, to unevenly distribute the powdered flame retardant in a surface layer of the fiber structure.

### Advantageous Effects of the Invention

According to the present invention, it is possible to produce a highly flame-retardant, lightweight, and high-strength fiber-reinforced composite material simply and conveniently.

### BRIEF DESCRIPTION OF THE DRAWINGS

FIG. 1 is a cross-sectional diagram of a production apparatus for producing, according to Embodiment 1 of the present invention, a fiber-reinforced composite material;

FIG. 2 is a flow diagram of the method according to Embodiment 1 of the present invention for producing a fiber-reinforced composite material;

FIG. 3 is a cross-sectional diagram of a fiber-reinforced composite material that has been produced by the production method of Embodiment 1 of the present invention;

FIG. 4 is a diagram that shows the course of impregnation for the bromine-containing resin in the production method of Embodiment 1 of the present invention;

FIG. 5 is a cross-sectional diagram of a production apparatus for producing, according to Embodiment 3 of the present invention, a sandwich panel;

FIG. 6 is a flow diagram of the method according to Embodiment 3 of the present invention for producing a sandwich panel;

FIG. 7 is an explanatory diagram that shows an example of the results of heat release testing on a carbon fiber-reinforced composite material according to Embodiment 4 of the present invention;

FIG. 8 is a cross-sectional diagram that shows a sandwich panel according to Embodiment 5 of the present invention;

FIG. 9 is a perspective diagram that shows the structure of an elevator car that uses a carbon fiber-reinforced composite material according to Embodiment 6 of the present invention;

FIG. 10 is a perspective diagram that shows the structure of an elevator car frame that uses a carbon fiber-reinforced composite material according to Embodiment 6 of the present invention;

FIG. 11 is a perspective diagram that shows the structure of an elevator cab that uses a carbon fiber-reinforced composite material according to Embodiment 6 of the present invention and a sandwich panel according to Embodiment 7 of the present invention; and

FIG. 12 is a perspective diagram of a conventional elevator panel.

### DESCRIPTION OF EMBODIMENTS

Preferred embodiments of the fiber-reinforced composite material according to the present invention, the method of producing it according to the present invention, and elevator component members according to the present invention are described herebelow with reference to the figures. Among the individual figures, the same parts or corresponding parts are indicated with the same reference number.

### Embodiment 1

This embodiment describes a production apparatus for producing a fiber-reinforced composite material in which a powdered flame retardant is unevenly distributed on the surface of a fiber structure and describes a method for producing a fiber-reinforced composite material in which a powdered flame retardant is unevenly distributed on the surface of a fiber structure.

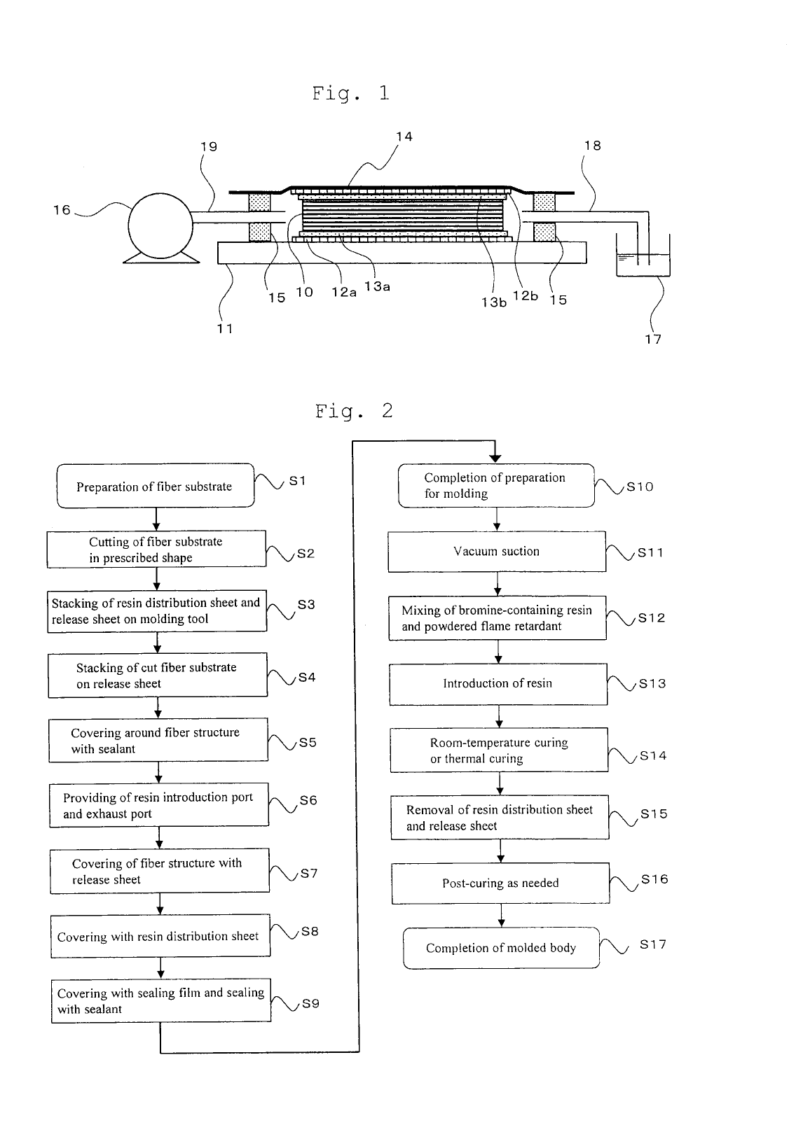

FIG. 1 is a cross-sectional diagram of a production apparatus for producing, according to Embodiment 1 of the present invention, a fiber-reinforced composite material. As shown in FIG. 1, this production apparatus for producing a fiber-reinforced composite material is provided with a molding tool 11 on which a fiber structure 10, e.g., a woven fabric, nonwoven fabric or nonwoven fabric-like molded body, and so forth, is disposed; a first resin distribution sheet 12a; a first release sheet 13a, which permits resin permeation to occur; a second release sheet 13b, which permits resin permeation to occur; a second resin distribution sheet 12b; a sealing film 14; a sealant 15, which isolates the space within the sealing film 14 from the outside; a vacuum pump 16, which evacuates the interior of the sealing film 14; and a resin tank 17, which feeds a bromine-containing resin to the interior of the sealing film 14.

The production apparatus is also provided with a resin introduction port 18, which introduces a bromine-containing resin supplied from the resin tank 17 into the interior of the sealing film 14. The production apparatus is additionally provided with an exhaust port 19, which exhausts the air present within the sealing film 14. This exhaust port 19 also functions as a discharge port for discharging excess bromine-containing resin from within the sealing film 14. The first resin distribution sheet 12a and the first release sheet 13a disposed on the molding tool 11 may be omitted. When this is done, a release treatment is preferably performed on the molding tool 11 in order to prevent sticking by the bromine-containing resin.

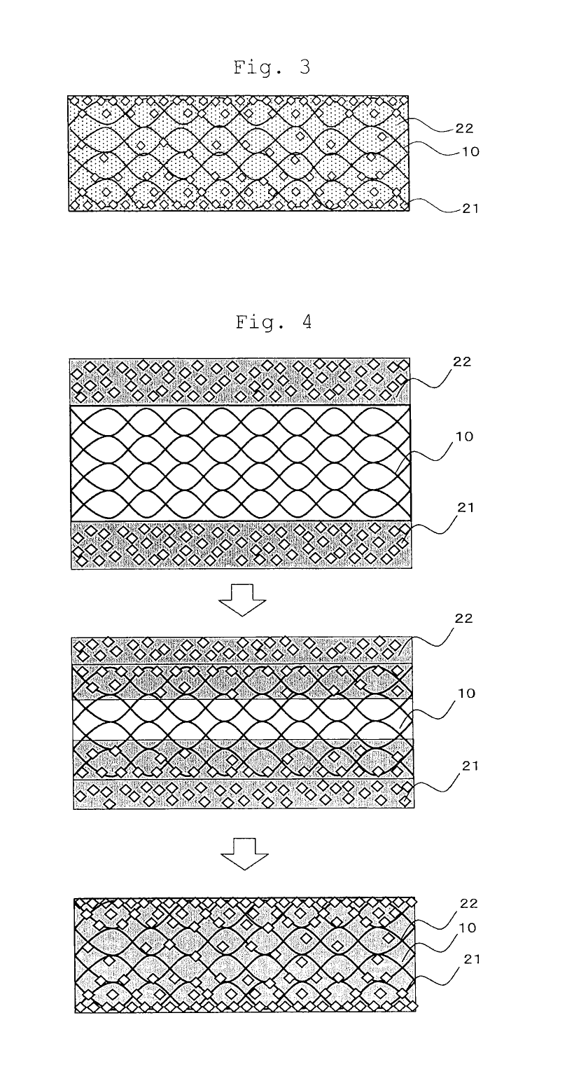

An example of the method of producing a fiber-reinforced composite material by using this production apparatus is explained herebelow with reference to FIG. 2.

First, a fiber substrate is prepared (step S1).

This fiber substrate is subsequently cut to a prescribed shape (step S2).

The first resin distribution sheet 12a and the first release sheet 13a are then successively stacked on the molding tool 11 (step S3). Again, this step may be omitted.

The cut fiber substrate is subsequently stacked on the first release sheet 13a (or on a release-treated molding tool 11 when the first resin distribution sheet 12a and the first release sheet 13a are omitted) to provide the fiber structure 10 (step S4).

The sealant 15 is then provided around the fiber structure 10 (step S5).

The resin introduction port 18 and the exhaust port 19 are subsequently put in place (step S6).

The surface of the fiber structure 10 is then covered with the second release sheet 13 (step S7).

The surface of the second release sheet 13b is subsequently covered with the second resin distribution sheet 12b (step S8).

The sealing film 14 is then applied so as to cover the fiber structure 10, thereby isolating the space within the sealing film 14 from the outside with the sealant 15 (step S9). At this stage, preparations for molding are completed as shown in FIG. 1 (step S10).

The vacuum pump 16 is subsequently started and the air within the sealing film 14 is exhausted (step S11).

The bromine-containing resin is then mixed with the powdered flame retardant to disperse the powdered flame retardant in the bromine-containing resin (step S12).

The powdered flame retardant+bromine-containing resin mixture filled into the resin tank 17 is introduced through the resin introduction port 18 into the space within the sealing film 14 and is impregnated into the fiber structure 10 (step S13). When this is done, the powdered flame retardant+bromine-containing resin mixture is filtered by the openings in the fiber substrate, which brings about distribution of the powdered flame retardant in the surface layer of the fiber structure 10.

The bromine-containing resin introduced into the sealing film 14 is subsequently cured (step S14). The curing method used here can cure at room temperature or cure with the application of heat, depending on the catalyst and type of bromine-containing resin selected.

Then, once the bromine-containing resin has undergone curing to a degree sufficient to enable removal of the molding tool 11, the second release sheet 13b is peeled off together with the second resin distribution sheet 12b to provide a molded body that is a fiber-reinforced composite material in which the fiber structure 10 is impregnated with the bromine-containing resin, which is removed from the molding tool 11 (step S15).

As necessary, a post-cure treatment with a drying oven is subsequently carried out on the recovered molded body (step S16).

The molded body composed of a fiber-reinforced composite material is obtained (step S17).

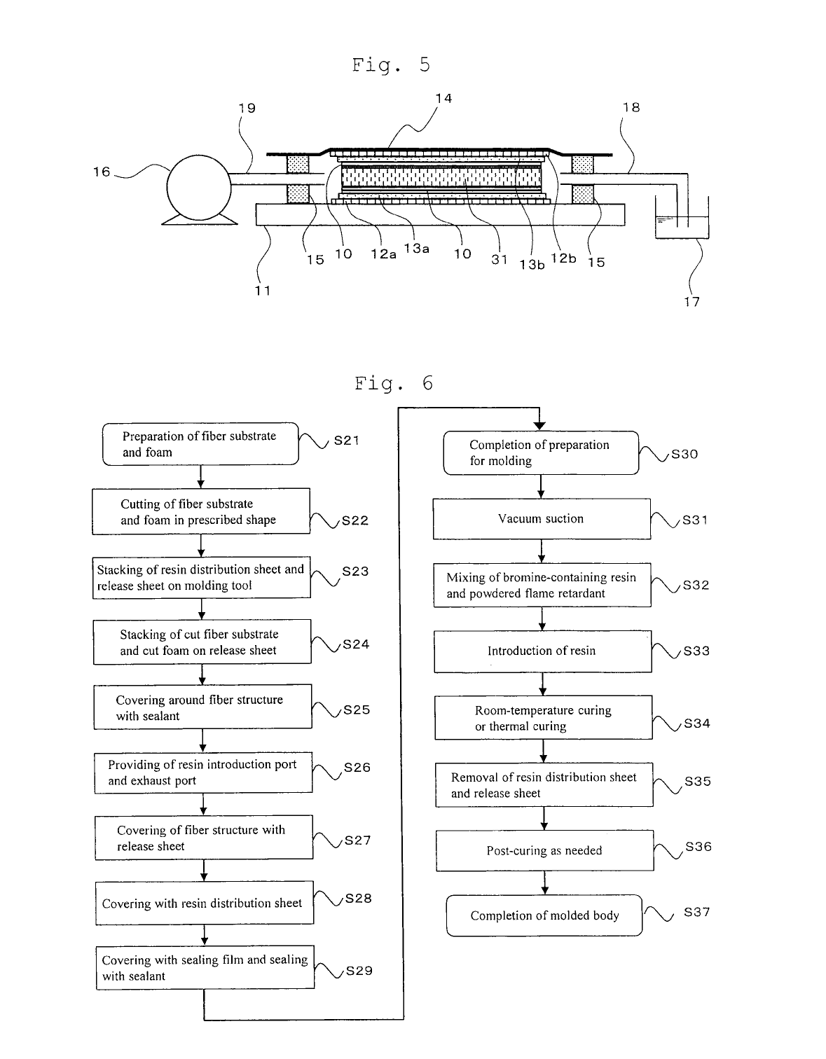

A fiber-reinforced composite material in which a powdered flame retardant 21 is unevenly distributed in the surface layer of the fiber structure 10, as shown in FIG. 3, can thus be obtained by the aforementioned method for producing a fiber-reinforced composite material. As shown in FIG. 4, the mixture of the powdered flame retardant 21 and the bromine-containing resin 22 introduced from the resin tank in step S13 is spread by the resin distribution sheet in the surface direction of the fiber structure 10. When this mixture undergoes impregnation into the fiber structure 10, the powdered flame retardant 21 is filtered by the openings in the fiber substrate and as a consequence its impregnation into the interior of the fiber structure 10 is impeded and it is unevenly distributed in the surface layer of the fiber structure 10.

In the fiber structure 10 disposed on the molding tool 11, the positions of the openings present in the individual layers (fiber substrates) of the fiber structure 10 are shifted by the stacking, and the number of openings that penetrate from front to back by line of sight declines with greater stacking of the fiber substrate. During impregnation, a portion of the mixture of the powdered flame retardant 21 and the bromine-containing resin 22 traverses the openings in the fiber substrate and the interlayers of the fiber structure 10 and impregnates the entire fiber structure 10.

The possible states for the distribution of the powdered flame retardant 21 include, for example, the case in which the powdered flame retardant 21 is present only at the surface layer; the case in which the powdered flame retardant 21 is present only in the vicinity of the surface layer and within the openings in the vicinity of the surface layer; the case in which, as shown in FIG. 4, the concentration of the powdered flame retardant 21 is higher in particular in the vicinity of the surface layer and in the openings in the vicinity of the surface layer and in which the concentration of the powdered flame retardant 21 is lower in the interior of the fiber structure 10; and the case in which the powdered flame retardant 21 exhibits a gradient distribution moving from the surface layer to the interior of the fiber structure 10. The fiber-reinforced composite material obtained as herein described exhibits a very high flame retardancy because the powdered flame retardant 21 is densely present at the surface layer and because the powdered flame retardant 21 also exhibits a heat-shielding effect. The state of the distribution of the powdered flame retardant 21 can be checked by microscopic observation of the cross section of the fiber-reinforced composite material.

Each layer (fiber substrate) of the fiber structure 10 must have a mode value for the size of the fiber-surrounded individual openings in the range of 0.03 to 3 mm² and an opening area percentage per 10 cm² of surface in the range of 0.1 to 10%. When the mode value for the size of the openings is less than 0.03 mm², the bromine-containing resin 22 will not undergo a satisfactory impregnation into the interior of the fiber structure 10. When, on the other hand, the mode value for the size of the openings exceeds 3 mm², distribution of the powdered flame retardant 21 in the surface layer of the fiber structure 10 cannot then be brought about. In addition, when the opening area percentage is less than 0.1%, the bromine-containing resin 22 will not undergo a satisfactory impregnation into the interior of the fiber structure 10. When, on the other hand, the opening area percentage exceeds 10%, distribution of the powdered flame retardant 21 in the surface layer of the fiber structure 10 cannot then be brought about. The fiber substrate preferably has a mode value for the size of the openings in the range of 0.2 to 0.6 mm² and an opening area percentage per 10 cm² of area in the range of 0.8 to 6.3%.

In the present invention, an opening denotes the space in a mesh produced by the orthogonal disposition of warp and weft fibers. The opening area percentage denotes the numerical value that represents the percentage of the area occupied by the openings, with reference to the total area of 1 layer (1 ply) of fiber substrate. For a unidirectional cloth in which the fibers are oriented only in one direction, an opening denotes the space produced between the lengthwise fibers and the transverse fibers (e.g., glass fibers) intertwined orthogonal to the fiber direction and used to fix the longitudinal fibers.

Measurement of the area of the openings and calculation of the opening area percentage are preferably carried out by measuring the area of the openings in a fiber substrate having a total surface area of 100 cm² per ply. The mode value here is the value that occurs with the highest frequency in the data set or probability distribution.

The type of fiber making up the fiber substrate can be exemplified by inorganic fibers such as carbon fibers, glass fibers, and alumina fibers and by organic fibers such as aramid fibers. Carbon fibers are preferred among the preceding because they provide a lightweight high-strength fiber-reinforced composite material.

The following, for example, can be used for the fiber substrate: various cloths such as plain weaves, twill weaves, and satin weaves, and unidirectional cloth provided by converting fibers lined up in a single direction into a sheet by bundling with separate fibers.

Viewed in terms of the strength and flame retardancy, the fiber volumetric content (Vf), which gives the ratio of the volume occupied by the fiber structure 10 to the total volume of the fiber-reinforced composite material, is preferably from 25 to 85% by volume and is more preferably from 40 to 75% by volume. When the ratio of the volume occupied by the fiber structure 10 is less than 25% by volume, the reinforcing effect provided by the fiber is unsatisfactory and the flame retardancy may also be unsatisfactory. When, on the other hand, the ratio of the volume occupied by the fiber structure 10 exceeds 85% by volume, a reduction occurs in the ability of the bromine-containing resin 22 to tie the fibers together, and as a result the strength declines and molding may become problematic.

The powdered flame retardant 21 contains at least one component selected from aluminum hydroxide and magnesium hydroxide and has an average particle size in the range of 0.1 to 20 μm. When the average particle size of the powdered flame retardant 21 is less than 0.1 μm, distribution of the powdered flame retardant 21 in the surface layer of the fiber structure 10 cannot be brought about and a satisfactory flame retardancy is then not obtained. When the average particle size of the powdered flame retardant 21 exceeds 20 μm, the powdered flame retardant 21 clogs the first release sheet 13a and the second release sheet 13b and molding then becomes problematic. The average particle size of the powdered flame retardant 21 is preferably 0.5 to 10 μm. At least one component selected from aluminum hydroxide and magnesium hydroxide used for the powdered flame retardant 21 is preferably added at 5 to 200 parts by weight and more preferably at 10 to 50 parts by weight, in each case per 100 parts by weight of the bromine-containing resin 22.

Besides aluminum hydroxide and magnesium hydroxide, the powdered flame retardant 21 may further contain at least one component selected from antimony trioxide and zinc borate. At least one component selected from antimony trioxide and zinc borate can be added in the range of 0 to 20 parts by weight per 100 parts by weight of the bromine-containing resin 22.

In addition, an additive-type or reactive flame retardant, e.g., a phosphate ester flame retardant, phosphorus-boron compound, and so forth, may be co-used to bring about a further improvement in the flame retardancy.

In the present invention, the average particle size refers to the value of the particle size when the total for the volume percent equal to and less than a certain particle size, with reference to the total value for the volume percent of the measured particles, reaches 50%.

The bromine-containing resin 22 is preferably bromine-containing thermosetting resins. Among them, a simplification of the production process can be achieved by using a brominated unsaturated polyester resin or a brominated epoxy acrylate resin because this enables curing to be carried out at room temperature.

Brominated unsaturated polyester resin as obtained by the introduction of bromine in the production stage or the mixing of a brominated monomer can be used as the brominated unsaturated polyester resin. For example, the following four methods can be used as methods for introducing bromine in the production stage.

The first method is a method that uses dibromoneopentyl glycol as a polyhydric alcohol component.

The second method is a method that uses tetrabromophthalic acid or its anhydride as a saturated dibasic acid or anhydride thereof.

The third method is a method in which an unsaturated polyester is produced by using, for example, tetrahydrophthalic acid or its anhydride or endomethylene tetrahydrophthalic acid or its anhydride as a saturated dibasic acid or anhydride thereof, followed by the addition of bromine across the double bond in this saturated dibasic acid component.

The fourth method is a method in which an unsaturated polyester is produced by using a dicyclopentadiene-maleic acid adduct—which combines the function of a saturated dibasic acid component with the function of an α,β—unsaturated dibasic acid component—for a part of the starting material, followed by the addition of bromine across the residual double bond in the dicyclopentadiene.

A brominated epoxy acrylate resin obtained by the introduction of bromine in the production stage or the mixing of a brominated monomer can also be used as the brominated epoxy acrylate resin. The method of introducing bromine in the production stage can be exemplified by methods that use a bromine-containing epoxy-type epoxy resin as the epoxy compound.

Viewed from the standpoint of obtaining an excellent flexibility, the brominated epoxy acrylate resin is preferably a tetrabromobisphenol A-type epoxy(meth)acrylate, tetrabromobisphenol F-type epoxy(meth)acrylate, tetrabromobisphenol S-type (meth)acrylate, and so forth.

The bromine content in the brominated unsaturated polyester resin or brominated epoxy acrylate resin is preferably from 5 to 60% by weight and is more preferably from 10 to 40% by weight. It may not be possible to obtain a satisfactory flame retardancy when the bromine content is less than 5% by weight. A high toxicity upon combustion can occur when, on the other hand, the bromine content exceeds 60% by weight; moreover, it is difficult to obtain such resins having a bromine content in excess of 60% by weight.

The thickness of the fiber-reinforced composite material is selected based on economic considerations and design strength considerations, but a thickness of approximately 100 μm to 3 cm is preferred and a thickness of 0.5 mm to 1 cm is more preferred. Obtaining a satisfactory strength becomes problematic when the thickness of the fiber-reinforced composite material is less than 100 μm. The weight increases when, on the other hand, the thickness of the fiber-reinforced composite material exceeds 3 cm, and the lightweight character required of the fiber-reinforced composite material is then lost. In addition, when the fiber making up the fiber structure 10 is carbon fiber, the high cost of carbon fiber means that a fiber-reinforced composite material having a thickness in excess of 3 cm is also economically disadvantageous.

As has been described in the preceding, Embodiment 1 can produce a highly flame-retardant fiber-reinforced composite material and can do so using relatively inexpensive materials and a simple and convenient process that employs a vacuum-assisted atmospheric pressure injection method. In addition, the simplification of the production equipment and production process enables a lowering of the production costs and a shortening of the production time and enables the mass production of the fiber-reinforced composite material.

### Embodiment 2

In this embodiment, rather than making the fiber structure 10 as in Embodiment 1 by stacking fiber substrates that have been cut into a prescribed shape, the fiber structure 10 is prepared by winding a continuous fiber on a die and a fiber-reinforced composite material in which the powdered flame retardant 21 is unevenly distributed in the surface layer of the fiber structure is then produced by impregnating this fiber structure 10 with the mixture of the powdered flame retardant 21 and the bromine-containing resin 22 from the surface direction of the fiber structure 10.

The type of continuous fiber can be exemplified by inorganic fibers such as carbon fibers, glass fibers, and alumina fibers and by organic fibers such as aramid fibers. Carbon fibers are preferred among the preceding because they provide a lightweight high-strength fiber-reinforced composite material. There are no particular limitations on the fiber diameter of the continuous fiber, but from 1 μm to 20 μm is preferred.

The powdered flame retardant 21 and the bromine-containing resin 22 used here can be the same as those in Embodiment 1.

The fiber volumetric content and thickness of the fiber-reinforced composite material are the same as for the previously described Embodiment 1.

### Embodiment 3

This embodiment describes a production apparatus for producing a fiber-reinforced composite material panel (hereafter referred to as a sandwich panel) in which a powdered flame retardant 21 is unevenly distributed on the surface of a structure itself provided by sandwiching both surface sides of a core material made of a foam between fiber structures 10, and also describes a method of producing this sandwich panel.

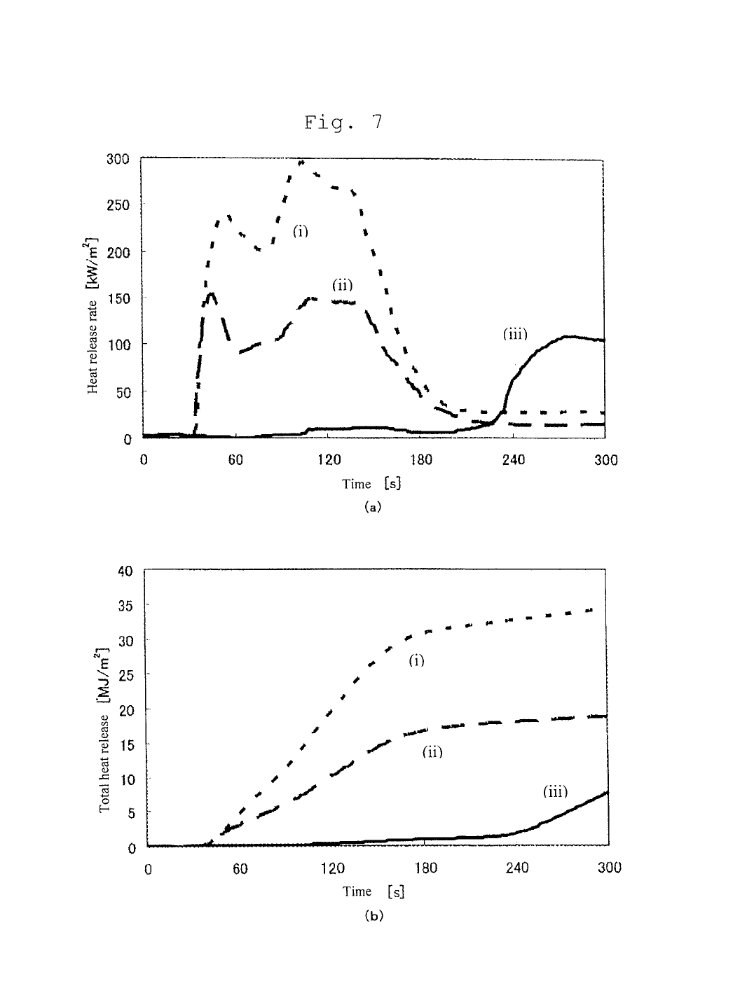

FIG. 5 is a cross-sectional diagram of a sandwich panel production apparatus according to Embodiment 3. As shown in FIG. 5, this sandwich panel production apparatus is provided with a molding tool 11 on which a fiber structure 10 and a foam 31 are stacked in succession; a first resin distribution sheet 12a; a first release sheet 13a, which permits resin permeation to occur; a second release sheet 13b, which permits resin permeation to occur; a second resin distribution sheet 12b; a sealing film 14; a sealant 15, which isolates the space within the sealing film 14 from the outside; a vacuum pump 16, which evacuates the interior of the sealing film 14; and a resin tank 17, which feeds a bromine-containing resin into the interior of the sealing film 14.

This production apparatus is also provided with a resin introduction port 18, which introduces a bromine-containing resin fed from the resin tank 17 into the sealing film 14. The production apparatus is also provided with an exhaust port 19, which exhausts the interior of the sealing film 14. This exhaust port 19 also functions as a discharge port that discharges excess bromine-containing resin from within the sealing film 14. The first resin distribution sheet 12a and the first release sheet 13a disposed on the molding tool 11 may be omitted. When this is done, a release treatment is preferably performed on the molding tool 11 in order to prevent sticking by the bromine-containing resin.

An example of the method of producing a sandwich panel by using this production apparatus is described herebelow with reference to FIG. 6.

A fiber substrate and a foam 31 are first prepared (step S21).

This fiber substrate and the foam 31 are subsequently cut to prescribed shapes (step S22).

The first resin distribution sheet 12a and the first release sheet 13a are then successively stacked on the molding tool 11 (step S23). Again, this step may be omitted.

The cut fiber substrate is subsequently stacked on the first release sheet 13a (or on a release-treated molding tool 11 when the first resin distribution sheet 12a and the first release sheet 13a are omitted) to provide a fiber structure 10; the cut foam 31 is placed on this fiber structure 10; and the cut fiber substrate is additionally stacked on this foam 31 to provide a fiber structure 10, thereby yielding a state in which both surface sides of the foam 31 are sandwiched between the fiber structures 10 (step S24). The fiber structure 10 may also be stacked on only one surface of the foam 31.

The sealant 15 is then provided around the structure in which both surface sides of the foam 31 are sandwiched between the fiber structures 10 (step S25).

The resin introduction port 18 and the exhaust port 19 are subsequently put in place (step S26).

The surface of the structure in which both surface sides of the foam 31 are sandwiched between the fiber structures 10 is then covered with the second release sheet 13b (step S27).

The surface of the second release sheet 13b is subsequently covered with the second resin distribution sheet 12b (step S28).

The sealing film 14 is then applied so as to cover the structure in which both surface sides of the foam 31 are sandwiched between the fiber structures 10, thereby isolating the space within the sealing film 14 from the outside with the sealant 15 (step S29). At this stage, preparations for molding are completed as shown in FIG. 5 (step S30).

The vacuum pump 16 is subsequently started and the air within the sealing film 14 is exhausted (step S31).

The bromine-containing resin 22 is then mixed with the powdered flame retardant 21 to disperse the powdered flame retardant 21 in the bromine-containing resin 22 (step S32).

The mixture of the powdered flame retardant 21 and the bromine-containing resin 22 filled into the resin tank 17 is introduced through the resin introduction port 18 into the space within the sealing film 14 and is impregnated into the fiber structure 10 (step S33). When this is done, the mixture of the powdered flame retardant 21 and the bromine-containing resin 22 is filtered by the openings in the fiber substrate, which brings about distribution of the powdered flame retardant 21 in the surface layer of the fiber structure 10.

The bromine-containing resin 22 introduced into the sealing film 14 is subsequently cured (step S34). The curing method used here can be done at room temperature or with the application of heat, depending on the catalyst and the type of the bromine-containing resin 22 selected.

Then, once the bromine-containing resin 22 has undergone curing to a degree sufficient to enable removal of the molding tool 11, the second release sheet 13b is peeled off together with the second resin distribution sheet 12b to provide a molded body that is a sandwich panel in which both surface sides of the foam 31 are sandwiched by fiber structures 10 impregnated with the bromine-containing resin 22 and having the powdered flame retardant 21 unevenly distributed in the surface layer, which is removed from the molding tool 11 (step S35).

As necessary, a post-cure treatment with a drying oven is subsequently carried out on the recovered molded body (step S36).

The molded body composed of the sandwich panel is obtained (step S37).

The above-described method of producing a sandwich panel can thus yield a highly flame-retardant sandwich panel in which, as in Embodiment 1, the powdered flame retardant 21 is unevenly distributed in the surface layer of the fiber structure 10.

The same fiber structure 10 as in Embodiment 1 and Embodiment 2 can be used for the fiber structure 10 here. The powdered flame retardant 21 and the bromine-containing resin 22 used here can be the same as those in Embodiment 1.

The foam 31 is formed, for example, from a rigid foam (foamed material) of, e.g., a polyvinyl chloride resin, polyurethane resin, polystyrene resin, polyethylene resin, polypropylene resin, acrylic resin, phenolic resin, polymethacrylimide resin, epoxy resin, ethylene-propylene rubber, and so forth. When the foam 31 is to be used for integral molding, the foamed portion is preferably not continuous and a closed-cell foam is preferably used. An inorganic foam, e.g., an aluminum foam, or a syntactic foam may also be used for the foam 31. In particular, phenolic resin foams and flame retardant foams provided by mixing a flame retardant into a resin material as described above and foaming are preferred for the foam 31 because they exhibit an excellent flame retardancy. Because the flame retardancy is boosted still further by the use of a flame retardant foam for the foam 31, the resulting sandwich panel is advantageously used for elevator component members for which a high reliability is required. A honeycomb may also be used as the core material in place of the foam 31.

In order to achieve additional weight reductions for the sandwich panel, a foam 31 is preferably used that has a density in the range of 0.01 to 0.2 g/cm³. The sandwich panel is susceptible to buckling when the density of the foam 31 is less than 0.01 g/cm³. Weight reduction for the sandwich panel may be impaired when, on the other hand, the density of the foam 31 is larger than 0.2 g/cm³.

The fiber volumetric content and thickness of the fiber-reinforced composite material are the same as for previously described Embodiment 1.

As has been described in the preceding, Embodiment 3 can produce a highly flame-retardant sandwich panel favorable for application as an elevator component member and can do so using relatively inexpensive materials and a simple and convenient process that employs a vacuum-assisted atmospheric pressure injection method. In addition, the simplification of the production equipment and production process enables a lowering of the production costs and a shortening of the production time and enables mass production of sandwich panels.

### Embodiment 4

In this embodiment, a carbon fiber-reinforced composite material (carbon-fiber reinforced plastic or CFRP) in which a powdered flame retardant 21 is unevenly distributed in the surface layer of a carbon fiber structure, is produced as in Embodiment 1 or 2 by using a carbon fiber as the fiber by impregnating a carbon fiber structure with a mixture of a powdered flame retardant 21 and a bromine-containing resin 22 from the surface direction of the carbon fiber structure.

The following, for example, can be used for the carbon fiber substrate: various carbon fiber cloths such as plain weaves, twill weaves, and satin weaves, and unidirectional cloth provided by converting carbon fibers lined up in a single direction into a sheet by bundling with separate fibers. There are no particular limitations on the fiber diameter of the continuous carbon fiber, but from 1 μm to 20 μm is preferred.

The powdered flame retardant 21 and the bromine-containing resin 22 used here can be the same as those in Embodiment 1.

According to Article 108-2 of the Enforcement Order for the Japanese Building Standard Law, the following are stipulated for a flame retardant material according to the Japanese Building Standard Law: “(1) It does not burn. (2) It does not undergo deformation, melting, cracking, or other damage detrimental to fire prevention. (3) It does not produce smoke or gas detrimental to evacuation.”. Here, in order to receive certification by the Ministry of Land, Infrastructure, Transport and Tourism and be recognized as a flame retardant material, the following—as specified in the flame-retardancy performance tests carried out by a performance evaluation organization so designated by the Ministry of Land, Infrastructure, Transport and Tourism—must be passed: a heat release test or a model box text, and a gas toxicity test.

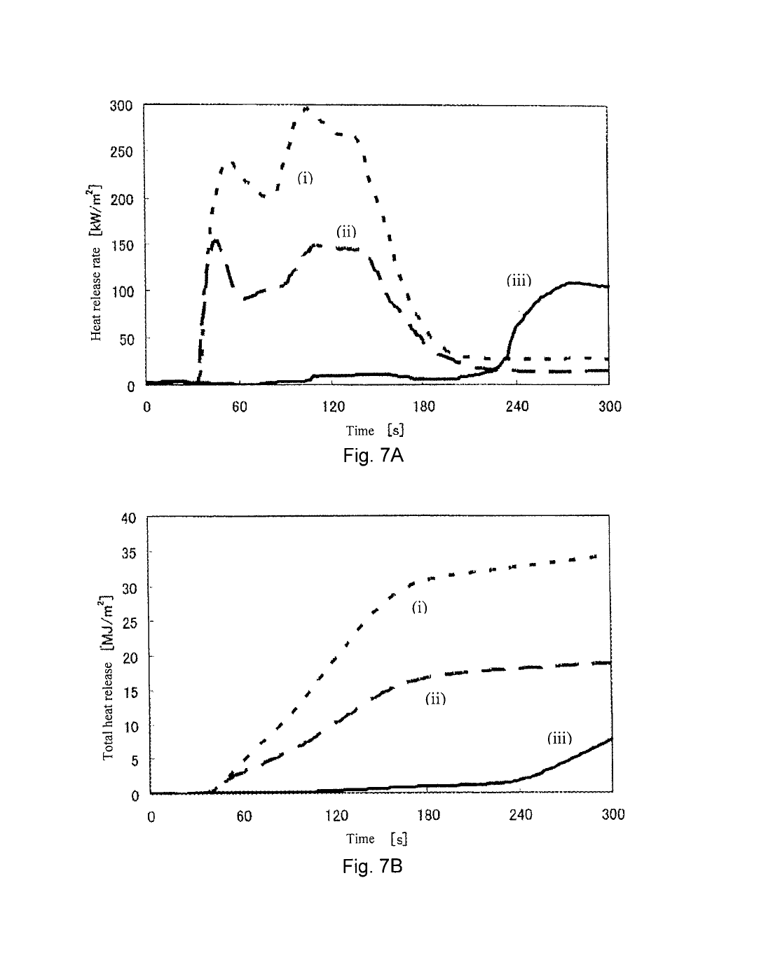

FIG. 7 gives an example of the results of heat release tests on a carbon fiber-reinforced composite material according to Embodiment 4. FIG. 7(a) gives the heat release rate, and FIG. 7(b) gives the total heat release. In FIGS. 7(a) and 7(b), (i) indicates the results for a carbon fiber-reinforced composite material obtained by impregnating the carbon fiber structure with a bromine-free resin; (ii) indicates the results for a carbon fiber-reinforced composite material obtained by impregnating the carbon fiber structure with a bromine-containing resin; and (iii) indicates the results for a carbon fiber-reinforced composite material obtained by impregnating the carbon fiber structure with a resin mixture prepared by the addition of 120 parts by weight aluminum hydroxide and 6 parts by weight antimony trioxide to 100 parts by weight of a bromine-containing resin (Embodiment 4).

A comparison of (i) and (ii) in FIGS. 7(a) and 7(b) demonstrates that the heat release rate is restrained by the use of the bromine-containing resin and that, while the total heat release is reduced, the resin fraction is completely burned.

In contrast to this, in the case of (iii), the time at which the heat release rate begins to rise, i.e., the ignition time, is retarded and “(1) The total heat release at 5 minutes after the start of heating is not more than 8 MJ/m². (2) The maximum heat release rate during 5 minutes after the start of heating does not exceed 200 kW/m² continuing for 10 seconds or more” are achieved.

This retardation of the ignition time and inhibition of the heat release rate are synergetic effects from the powdered flame retardant and bromine-containing resin. The carbon fiber-reinforced composite material according to Embodiment 4 can thus bring about an improved flame retardancy over that of conventional materials and can meet the flame-retardant material criteria established in the Japanese Building Standard Act. That is, in the carbon fiber-reinforced composite material according to Embodiment 4, the carbon fiber, which is a highly flame-retardant fiber, forms a heat-resistant heat-shielding layer and the duration of resin combustion is restrained and a flame-retarding effect is exhibited. Moreover, in addition to the flame-retarding effect of the bromine-containing resin, due to the presence of at least one component selected from aluminum hydroxide and magnesium hydroxide, the amount of resin is reduced and, in combination with a suppression of the amount of combustion, the rise in temperature is also suppressed through the heat-absorbing action during thermal degradation and a flame-extinguishing action can be obtained due to the production of water vapor.

Moreover, as described in FIG. 7, a synergetic effect can be obtained in which the heat-absorbing action during thermal degradation of at least one component selected from aluminum hydroxide and magnesium hydroxide causes the bromine-mediated flame retardant effect to last over an extended period of time. In addition, because the inorganic material remaining after the thermal degradation of at least one component selected from aluminum hydroxide and magnesium hydroxide stays in the gaps in the carbon fiber, the heat-shielding effect can be raised still further and a high flame retardancy can be obtained.

Moreover, when a continuous carbon fiber is used, a high strength can be achieved due to the fiber reinforcement and, in combination with this, the shape is maintained post-combustion.

The fiber volumetric content and thickness of the carbon fiber-reinforced composite material are the same as for previously described Embodiment 1.

As described above, Embodiment 4 can provide a highly flame-retardant, lightweight, and high-strength carbon fiber-reinforced composite material at low cost by a simple and convenient process. The carbon fiber-reinforced composite material according to Embodiment 4, because it can meet the flame-retardant material criteria established in the Japanese Building Standard Act, can advantageously be used for elevator component members.

### Embodiment 5

In this embodiment, a carbon fiber-reinforced composite material panel (hereafter referred to as a sandwich panel) is produced in which a powdered flame retardant is unevenly distributed in the surface of a structure itself provided by sandwiching both surface sides of a core material made of a foam between carbon fiber structures. This sandwich panel can be produced by a method in which a carbon fiber-reinforced composite material fabricated according to Embodiment 4 is adhered to a core material by using an adhesive or can be produced by integral molding according to Embodiment 3.

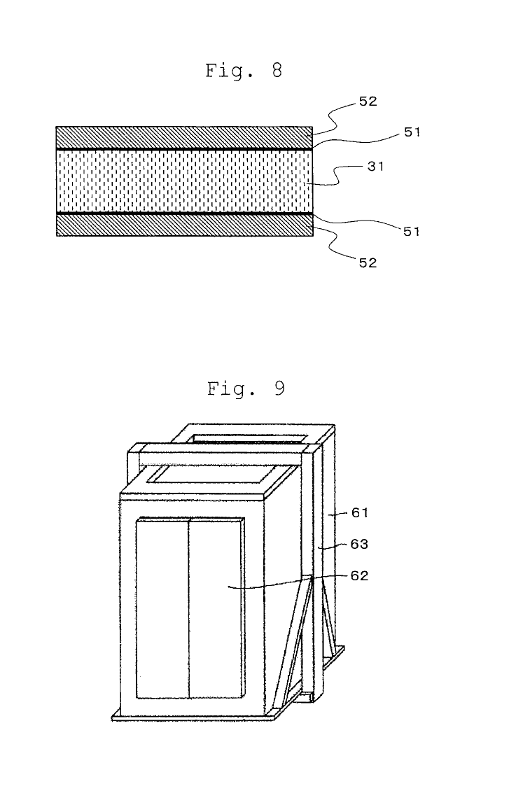

FIG. 8 is a cross-sectional diagram that shows a sandwich panel according to Embodiment 5. In the sandwich panel in FIG. 8, both surface sides of a core material made of a foam 31 are joined by an adhesive 51 to a carbon fiber-reinforced reinforced composite material 52. For example, an epoxy adhesive, acrylic adhesive, silicone adhesive, flame-retardant adhesive, and so forth, can be used for the adhesive 51. In addition, the adhesive layer can be integrated into the carbon fiber-reinforced composite material 52 by using the bromine-containing resin 22 used in the carbon fiber-reinforced composite material 52 as the adhesive 51. The carbon fiber-reinforced composite material 52 may also be joined to only one surface of the foam 31.

The powdered flame retardant 21 and the bromine-containing resin 22 used here can be the same as those in Embodiment 1.

The foam 31 used here can be the same as the foam in Embodiment 3. The carbon fiber substrate and the continuous carbon fiber used here can be the same as those in Embodiment 4.

The fiber volumetric content and thickness of the fiber-reinforced composite material are the same as for previously described Embodiment 1.

The sandwich panel according to Embodiment 5 provides an improved flame retardancy over conventional materials through synergetic effects among its component materials in accordance with the same mechanisms that improve the flame retardancy in the carbon fiber-reinforced composite material of Embodiment 4, and can meet the flame-retardant material criteria established in the Japanese Building Standard Law.

As has been described in the preceding, Embodiment 5 can provide a lightweight and highly flame-retardant sandwich panel that has a high stiffness and strength comparable to those of metals, and can do so at low cost by using a simple and convenient process. In addition to having a high rigidity and strength comparable to those of metals, the sandwich panel according to Embodiment 5 can meet the flame-retardant material criteria established in the Japanese Building Standard Law and because of this can be favorably used for elevator component members and particularly for elevator cars.

### Embodiment 6

This embodiment describes an elevator car (cab and car frame) that uses a carbon fiber-reinforced composite material fabricated according to Embodiment 4.

An elevator car will be described, with reference to FIGS. 9 to 12, that uses this carbon fiber-reinforced composite material for the component members (car component members) of the elevator cab and car frame.

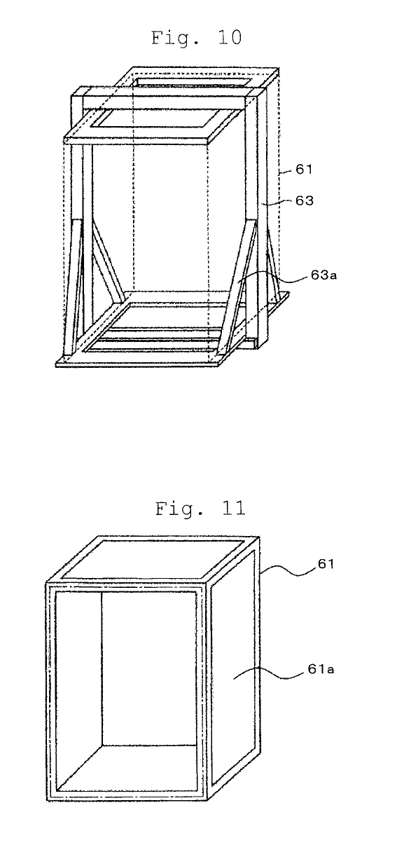

As shown in FIG. 9, an elevator car is provided with a cab 61 that holds, e.g., people and objects; a car door 62 for the entrance and egress of, for example, people; and a car frame 63. As shown in FIG. 10, the car frame 63 is provided in order to reinforce the cab 61. The carbon fiber-reinforced composite material can be used in particular for all of the car frame 63 or for a portion thereof, e.g., a diagonal strut 63a (support element) and so forth.

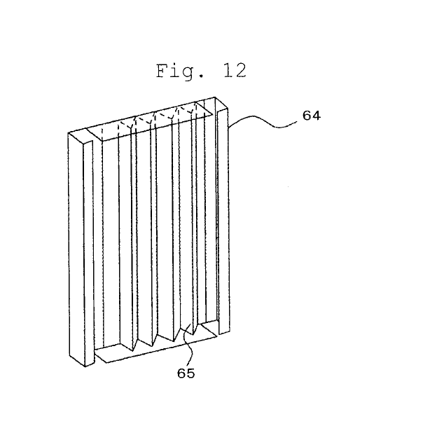

As shown in FIG. 11, the carbon fiber-reinforced composite material can also be used for the elevator panels 61a used as floor boards, ceiling panels, side panels, and rear panels for the cab 61. The carbon fiber-reinforced composite material may also be used as a portion of the component materials of elevator panels. For example, in the conventional elevator panel shown in FIG. 12, the carbon fiber-reinforced composite material can be used as a reinforcement 65 attached to the back side of a metal front panel 64.

Elevator car members that use the hereinabove-described carbon fiber-reinforced composite material can reliably and securely maintain a satisfactory strength that is not inferior to that of conventional materials. Specifically, the specific strength (a relative expression), which gives the strength per weight, is approximately 0.5 for iron and approximately 0.8 for aluminum in comparison to approximately 5 for the carbon fiber-reinforced composite material, and, for the same structure, the weight thereof can then be reduced to, for example, one-sixth to one-tenth the weight of a conventional elevator panel.

Since an elevator car that exhibits a lower inertia and supports easier operational control can be fabricated when the carbon fiber-reinforced composite material is used for an elevator car member, a downsizing of the elevator system as a whole, for example, a reduction in the motor capacity, can thus be achieved. Moreover, the previously indicated conditions established in Article 108-2 of the Enforcement Order for the Japanese Building Standard Law can be satisfied. The weight reduction achieved for the elevator car also makes it possible to save on the labor required for installation.

While Embodiment 6 has been described by using the application of the carbon fiber-reinforced composite material to elevator car members as an example, the applications of the carbon fiber-reinforced composite material according to Embodiment 4 are not limited to this.

### Embodiment 7

This describes an elevator car that uses a sandwich panel fabricated according to Embodiment 3 or 5 for component members (car members) of an elevator cab or car frame. As shown in FIG. 11, the sandwich panel can be used, for example, for the elevator panels 61a used for the floor boards, ceiling panels, side panels, and rear panels of the cab 61. The sandwich panel is preferably used for at least one of the floor boards, ceiling panels, side panels, and rear panels.

Elevator panels that use the hereinabove-described sandwich panels can, with respect to impact forces, reliably and securely maintain a low flexibility and satisfactory strength that are not inferior to conventional elevator panels fabricated of metal sheet. In addition, their weight can be reduced to, for example, one-third to one-fifth (approximately 7 kg for a CFRP sandwich panel) of the weight of conventional elevator panels (approximately 36 kg for iron-based, approximately 20 kg for aluminum mixtures).

Since an elevator car that exhibits a lower inertia and supports easier operational control can be fabricated when the sandwich panel is used for an elevator car member, a downsizing of the elevator system as a whole, for example, a reduction in the motor capacity, can thus be achieved. Moreover, the previously indicated conditions established in Article 108-2 of the Enforcement Order for the Japanese Building Standard Law can be satisfied.

While Embodiment 7 has been described by using the application of the sandwich panel to elevator car members as an example, the applications of sandwich panels according to Embodiment 3 and Embodiment 5 are not limited to this.

While the examples in Embodiment 6 and Embodiment 7 use elevator car members as application examples, the fiber-reinforced composite materials and sandwich panels according to the present invention can also be applied in fields such as electrical products, building products, and mechanical products.

While the description of Embodiment 7 uses the application of the sandwich panel as an elevator panel as an example for the sandwich panel, this sandwich panel is not limited to elevator panels and can also be used for, for example, structures in satellites.

With regard to the flame retardancy criteria, the fiber-reinforced composite materials and sandwich panels according to the present invention are targeted to the very highest levels of flame retardancy, and, considering the VO flame retardancy rating established by UL 94, which is applied to general electric products, exhibit a high flame retardancy that easily meets the VO level and are thus very useful in applications where a high degree of flame retardancy is required.

### EXAMPLES

The fiber-reinforced composite material of the present invention is specifically described by using examples. However, the present invention is not limited to or by these examples.

The fiber-reinforced composite materials of Examples 1 to 5 and Comparative Examples 1 to 6 were fabricated by using the materials described below and the production apparatus shown in FIG. 1. The average particle size for each powdered flame retardant is the value provided in the manufacturer's catalogue.

<Materials Used >

Resin 1: brominated epoxy acrylate resin (NEOPOL (registered trademark) 8197 from Japan U-Pica Company Ltd., bromine content=25 to 27% by weight)

Resin 2: brominated unsaturated polyester resin (FLH-350R from Japan U-Pica Company Ltd., bromine content=11% by weight).

Resin 3: epoxy acrylate resin (Ripoxy (registered trademark) R806 from Showa Denko K. K.)

Powdered flame retardant 1: aluminum hydroxide (HP-360 from Showa Denko K. K., average particle size=2.7 μm)

Powdered flame retardant 2: antimony trioxide (AN-800(T) from Dai-ichi Kogyo Seiyaku Co., Ltd., average particle size=1.25 μm)

Powdered flame retardant 3: aluminum hydroxide (HP-360 (grinding processed product) from Showa Denko K. K., average particle size=0.05 μm)

Powdered flame retardant 4: aluminum hydroxide (B52 from Nippon Light Metal Co., Ltd., average particle size=55 μm)

Curing agent 1: organoperoxide (328E from Kayaku Akzo Corporation)

Curing agent 2: methyl ethyl ketone peroxide·dimethyl phthalate solution (Permek (registered trademark) N from NOF Corporation, concentration=55% by weight)

Cure promoter: cobalt octenoate solution (Cobalt O from Showa Denko K. K., metal=8% by weight)

Fiber substrate 1: carbon fiber plain weave cloth (Torayca (registered trademark) Cloth T700S-12000 from Toray Industries, Inc., mode value=0.5 to 0.6 mm², opening area percentage=1.0%)

Fiber substrate 2: carbon fiber plain weave cloth (Torayca (registered trademark) Cloth T300-3000 from Toray Industries, Inc., mode value=0.2 to 0.25 mm², opening area percentage=6.2%)

Fiber substrate 3: carbon fiber plain weave cloth (plain woven obtained by using Torayca (registered trademark) T700S from Toray Industries, Inc., mode value=2.5 to 3.0 mm², opening area percentage=0.1%)

Fiber substrate 4: carbon fiber plain weave cloth (plain woven obtained by using Torayca (registered trademark) T700S from Toray Industries, Inc., mode value=0.03 to 0.05 mm², opening area percentage=6.5%)

Fiber substrate 5: carbon fiber plain weave cloth (plain woven obtained by using Torayca (registered trademark) T700S from Toray Industries, Inc., mode value=0.10 to 0.15 mm², opening area percentage=9.5%)

Fiber substrate 6: carbon fiber plain weave cloth (plain woven obtained by using Torayca (registered trademark) T700S from Toray Industries, Inc., mode value=0.01 to 0.03 mm², opening area percentage=0.05%)

Fiber substrate 7: carbon fiber plain weave cloth (plain woven obtained by using Torayca (registered k) T700S from Toray Industries, Inc., mode value=3.1 to 3.5 mm², opening area percentage=13%)

### Example 1

A fiber structure provided by stacking 8 plies of Fiber substrate 1 was placed on the molding tool and the release sheet and resin distribution sheet were successively placed thereon. These were covered with the sealing film; the space between the sealing film and molding tool was blocked with the sealant to achieve a complete seal; and the pressure within the sealed space was reduced by the vacuum pump. A resin composition prepared by the addition of 25 parts by weight of Powdered flame retardant 1, 6 parts by weight of Powdered flame retardant 2,part by weight of Curing agent 1, and 0.2 parts by weight of Cure promoter to 100 parts by weight of Resin 1, was subsequently injected through the resin introduction port into the evacuated sealed space and was thereby impregnated into the fiber structure. Curing of the resin was confirmed after 2 hours at room temperature, after which the sealing film was removed and the fiber-reinforced composite material was removed. In order to bring about complete curing, holding was carried out for 2 hours at 80° C., 2 hours at 100° C., and 2 hours at 120° C., thus yielding the fiber-reinforced composite material of Example 1.

### Example 2

A fiber structure provided by stacking 12 plies of Fiber substrate 1 was placed on the molding tool and the release sheet and resin distribution sheet were successively placed thereon. These were covered with the sealing film; the space between the sealing film and molding tool was blocked with the sealant to achieve a complete seal; and the pressure within the sealed space was reduced by the vacuum pump. A resin composition prepared by the addition of 25 parts by weight of Powdered flame retardant 1, 6 parts by weight of Powdered flame retardant 2, 1 part by weight of Curing agent 1, and 0.2 parts by weight of Cure promoter to 100 parts by weight of Resin 1, was subsequently injected through the resin introduction port into the evacuated sealed space and was thereby impregnated into the fiber structure. Curing of the resin was confirmed after 2 hours at room temperature, after which the sealing film was removed and the fiber-reinforced composite material was removed. In order to bring about complete curing, holding was carried out for 2 hours at 80° C., 2 hours at 100° C., and 2 hours at 120° C., thus yielding the fiber-reinforced composite material of Example 2.

### Example 3

The fiber-reinforced composite material of Example 3 was obtained in the same manner as in Example 1, except that Fiber substrate 3 was used instead of Fiber substrate 1.

### Example 4

The fiber-reinforced composite material of Example 4 was obtained in the same manner as in Example 1, except that Fiber substrate 4 was used instead of Fiber substrate 1.

### Example 5

The fiber-reinforced composite material of Example 5 was obtained in the same manner as in Example 1, except that Fiber substrate 5 was used instead of Fiber substrate 1.

### Comparative Example 1

The fiber-reinforced composite material of Comparative Example 1 was obtained in the same manner as in Example 2, except that Fiber substrate 2 was used instead of Fiber substrate 1, Resin 3 was used instead of Resin 1, and Powdered flame retardant 1 and Powdered flame retardant 2 were not added.

### Comparative Example 2

The fiber-reinforced composite material of Comparative Example 2 was obtained in the same manner as in Example 2, except that Fiber substrate 2 was used instead of Fiber substrate 1 and Powdered flame retardant 1 and Powdered flame retardant 2 were not added.

### Comparative Example 3

The fiber-reinforced composite material of Comparative Example 3 was obtained in the same manner as in Example 1, except that Fiber substrate 6 was used instead of Fiber substrate 1.

### Comparative Example 4

The fiber-reinforced composite material of Comparative Example 4 was obtained in the same manner as in Example 1, except that Fiber substrate 7 was used instead of Fiber substrate 1.

### Comparative Example 5

The fiber-reinforced composite material of Comparative Example 5 was obtained in the same manner as in Example 1, except that Powdered flame retardant 3 was used instead of Powdered flame retardant 1.

### Comparative Example 6

When the attempt was made to fabricate a fiber-reinforced composite material in the same manner as in Example 1, except that Powdered flame retardant 4 was used instead of Powdered flame retardant 1, molding could not be carried out due to an unsatisfactory resin impregnation.

<Evaluation of the flame retardancy >

Heat release testing by using a cone calorimeter was performed as a flame retardancy test conforming to the Japanese Building Standard Law. In this heat release test, in conformity with the heat release test specified in Article 108-2 of the Enforcement Order for the Japanese Building Standard Law, the maximum heat release rate and the total heat release were measured by running the test on a test specimen having a length of 100 mm for 1 test specimen piece using the following conditions: radiant intensity=50 kW/m² and a test time of 5 minutes.

The pass/fail determination criteria in the heat release test are as follows.

Maximum heat release rate: not to exceed 200 kW/m² continuing for 10 seconds or more

Total heat release: not more than 8 MJ/m² Other: holes and cracks penetrating to the back side and detrimental to fire prevention are not present

The results of the evaluation of the flame retardancy are given in Tables 1 and 2.

TABLE 1

| | | Example 1 | Example 2 | Example 3 | Example 4 | Example 5 |
|---|---|---|---|---|---|---|
| Component | Resin 1 (parts by weight) | 100 | 100 | 100 | 100 | 100 |
| materials | Powdered flame retardant 1 (parts by weight) | 25 | 25 | 25 | 25 | 25 |
| | Powdered flame retardant 2 (parts by weight) | 6 | 6 | 6 | 6 | 6 |
| | Powdered flame retardant 3 (parts by weight) | — | — | — | — | — |
| | Curing agent 1 (parts by weight) | 1 | 1 | 1 | 1 | 1 |
| | Cure promoter (parts by weight) | 0.2 | 0.2 | 0.2 | 0.2 | 0.2 |
| | Stacking of fiber substrate 1 (no. of plies) | 8 | 12 | — | — | — |
| | Stacking of fiber substrate 2 (no. of plies) | — | — | — | — | — |
| | Stacking of fiber substrate 3 (no. of plies) | — | — | 8 | — | — |
| | Stacking of fiber substrate 4 (no. of plies) | — | — | — | 8 | — |
| | Stacking of fiber substrate 5 (no. of plies) | — | — | — | — | 8 |
| | Stacking of fiber substrate 6 (no. of plies) | — | — | — | — | — |
| | Stacking of fiber substrate 7 (no. of plies) | — | — | — | — | — |
| Flame | Total heat release (MJ/m²) | 5.2 | 6.6 | 7.32 | 6.98 | 7.15 |
| retardancy | Maximum heat release rate (kW/m²) | 133.9 | 133.6 | 166.57 | 147.51 | 160.77 |
| evaluation | Post-combustion state | unburned resin | unburned resin | unburned resin | unburned resin | unburned resin |
| | | is present, | is present, | is present, | is present, | is present, |
| | | fiber fabric | fiber fabric | fiber fabric | fiber fabric | fiber fabric |
| | | maintains | maintains | maintains | maintains | maintains |
| | | shape | shape | shape | shape | shape |
| | Determination | meets flame- | meets flame- | meets flame- | meets flame- | meets flame- |
| | | retardant | retardant | retardant | retardant | retardant |
| | | material | material | material | material | material |
| | | criteria of the | criteria of the | criteria of the | criteria of the | criteria of the |
| | | Japanese | Japanese | Japanese | Japanese | Japanese |
| | | Building | Building | Building | Building | Building |
| | | Standard Act | Standard Act | Standard Act | Standard Act | Standard Act |

TABLE 2

| | | Comparative | Comparative | Comparative | Comparative | Comparative |
|---|---|---|---|---|---|---|
| | | Example 1 | Example 2 | Example 3 | Example 4 | Example 5 |
| Component | Resin 1 (parts by weight) | — | 100 | 100 | 100 | 100 |
| materials | Resin 3 (parts by weight) | 100 | — | — | — | — |
| | Powdered flame retardant 1 (parts by weight) | — | — | 25 | 25 | — |
| | Powdered flame retardant 2 (parts by weight) | — | — | 6 | 6 | 6 |
| | powdered flame retardant 3 (parts by weight) | — | — | — | — | 25 |
| | Curing agent 1 (parts by weight) | 1 | 1 | 1 | 1 | 1 |
| | Cure promoter (parts by weight) | 0.2 | 0.2 | 0.2 | 0.2 | 0.2 |
| | Stacking of fiber substrate 1 (no. of plies) | — | — | — | — | — |
| | Stacking of fiber substrate 2 (no. of plies) | 12 | 12 | — | — | — |
| | Stacking of fiber substrate 3 (no. of plies) | — | — | — | — | — |
| | Stacking of fiber substrate 4 (no. of plies) | — | — | — | — | — |
| | Stacking of fiber substrate 5 (no. of plies) | — | — | — | — | — |
| | Stacking of fiber substrate 6 (no. of plies) | — | — | 8 | — | — |
| | Stacking of fiber substrate 7 (no. of plies) | — | — | — | 8 | — |
| Flame | Total heat release (MJ/m²) | 34.2 | 16.3 | 10.51 | 11.32 | 9.33 |
| retardancy | Maximum heat release rate (kW/m²) | 296.5 | 124.4 | 189.88 | 203.27 | 191.64 |
| evaluation | Post-combustion state | resin fully | resin fully | resin fully | resin fully | resin fully |
| | | burned, fiber | burned, fiber | burned, fiber | burned, fiber | burned, fiber |
| | | fabric | fabric | fabric | fabric | fabric |
| | | maintains | maintains | maintains | maintains | maintains |
| | | shape | shape | shape | shape | shape |
| | Determination | — | — | — | — | — |

The fiber-reinforced composite materials of Examples 1 to 5 are shown to have a flame retardancy far superior to that in Comparative Examples 1 and 2, which lacked a powdered flame retardant. The fiber-reinforced composite materials of Examples 1 to 5 are also shown to meet the flame-retardant material criteria established in the Japanese Building Standard Law. An inadequate flame retardancy is shown, on the other hand, for the fiber-reinforced composite materials of Comparative Examples 3 and 4, which use fiber having an opening area percentage or a mode value for the opening size that is outside the scope of the present invention, and for the fiber-reinforced composite material of Comparative Example 5, which uses a powdered flame retardant having an average particle size outside the scope of the present invention.

The sandwich panels in Examples 6 to 9 and Comparative Examples 7 to 10 were fabricated by using the production apparatus shown in FIG. 5 and the previously described materials and using a phenolic resin foam (NEOMA (registered trademark) foam, from Asahi Kasei Corporation, thickness=25 mm, density=0.040 g/cm³) for core material 1 and a phenolic resin foam (NEOMA (registered trademark) foam, from Asahi Kasei Corporation, density=0.027 g/cm³) for core material 2.

### Example 6

Two fiber structures (thickness=0.8 to 1 mm) were prepared, in each case having 4 plies of Fiber substrate 1 stacked therein; Core material 1, sandwiched at both surface sides between these fiber structures, was placed on the molding tool; and the release sheet and resin distribution sheet were successively placed thereon. These were covered with the sealing film; the space between the sealing film and molding tool was blocked with the sealant to achieve a complete seal; and the pressure within the sealed space was reduced by the vacuum pump. A resin composition prepared by the addition of 25 parts by weight of Powdered flame retardant 1, 6 parts by weight of Powdered flame retardant 2, 1 part by weight of Curing agent 1, and 0.2 parts by weight of Cure promoter to 100 parts by weight of Resin 1, was subsequently injected through the resin introduction port into the evacuated sealed space and was thereby impregnated into the fiber structures. Curing of the resin was confirmed after 2 hours at room temperature, after which the sealing film was removed and the sandwich panel was taken off. In order to bring about complete curing, holding was carried out for 2 hours at 80° C., 2 hours at 100° C., and 2 hours at 120° C., thus yielding the sandwich panel of Example 6.

### Example 7

A sandwich panel was taken off in the same manner as in Example 6, except that a resin composition prepared by the addition of 80 parts by weight of Powdered flame retardant 1, 6 parts by weight of Powdered flame retardant 2, and 1 part by weight of Curing agent 2 to 100 parts by weight of Resin 2 was used. In order to complete the cure, the sandwich panel was held for 16 hours at 40° C. to obtain the sandwich panel of Example 7.

### Example 8

The sandwich panel of Example 8 was obtained in the same manner as in Example 6, except that a resin composition prepared by the addition of 6 parts by weight of Powdered flame retardant 1, 2 parts by weight of Powdered flame retardant 2, 1 part by weight of Curing agent 1, and 0.2 parts by weight of Cure promoter to 100 parts by weight of Resin 1 was used.

### Example 9

The sandwich panel of Example 9 was obtained in the same manner as in Example 6, except that Fiber substrate 2 was used instead of Fiber substrate 1 and Core material 2 was used instead of Core material 1.

### Comparative Example 7

The sandwich panel of Comparative Example 7 was obtained in the same manner as in Example 6, except that Fiber substrate 2 was used instead of Fiber substrate 1 and Powdered flame retardant 1 and Powdered flame retardant 2 were not added.

### Comparative Example 8

A sandwich panel was taken off in the same manner as in Example 6, except that Fiber substrate 2 was used instead of Fiber substrate 1 and a resin composition prepared by the addition of 1 part by weight of Curing agent 2 to 100 parts by weight of Resin 2 was used. In order to complete the cure, the sandwich panel was held for 16 hours at 40° C. to obtain the sandwich panel of Comparative Example 8.

### Comparative Example 9

The sandwich panel of Comparative Example 9 was obtained in the same manner as in Example 6, except that a resin composition prepared by the addition of 35 parts by weight of Powdered flame retardant 1, 1 part by weight of Curing agent 1, and 0.2 parts by weight of Cure promoter to 100 parts by weight of Resin 3 was used.

### Comparative Example 10

Two fiber structures (thickness=0.8 to 1 mm) were prepared, in each case having 4 plies of Fiber substrate 2 stacked therein, and Core material 1, sandwiched at both surface sides between these fiber structures, was impregnated by a hand lay-up method with a resin composition prepared by the addition of 6 parts by weight of Powdered flame retardant 2, 1 part by weight of Curing agent 1, and 0.2 parts by weight of Cure promoter to 100 parts by weight of Resin 1. In order to complete the cure, they were held for 2 hours at 80° C., 2 hours at 100° C., and 2 hours at 120° C., to obtain the sandwich panel of Comparative Example 10.

The results of the flame retardancy evaluations are given in Tables 3 and 4.

TABLE 3

| | | Example 6 | Example 7 | Example 8 | Example 9 |
|---|---|---|---|---|---|
| Component | Resin 1 (parts by weight) | 100 | — | 100 | 100 |
| materials | Resin 2 (parts by weight) | — | 100 | — | — |
| | Powdered flame retardant 1 (parts by weight) | 25 | 80 | 6 | 25 |
| | Powdered flame retardant 2 (parts by weight) | 6 | 6 | 2 | 6 |
| | Curing agent 1 (parts by weight) | 1 | — | 1 | 1 |
| | Curing agent 2 (parts by weight) | — | 1 | — | — |
| | Cure promoter (parts by weight) | 0.2 | — | 0.2 | 0.2 |
| | Stacking of fiber substrate 1 (no. of plies) | 4 | 4 | 4 | — |
| | Stacking of fiber substrate 2 (no. of plies) | — | — | — | 4 |
| | Core material | Core material 1 | Core material 1 | Core material 1 | Core material 2 |
| Flame | Total heat release (MJ/m²) | 4.6 | 6.4 | 3.8 | 7.9 |
| retardancy | Maximum heat release rate (kW/m²) | 143.6 | 186.6 | 154.3 | 193.0 |
| evaluation | Post-combustion state | resin burned, | resin burned, | resin burned, | resin burned, |
| | | fiber fabric | fiber fabric | fiber fabric | fiber fabric |
| | | maintains shape | maintains shape | maintains shape | maintains shape |
| | Determination | meets flame- | meets flame- | meets flame- | meets flame- |
| | | retardant | retardant | retardant | retardant |
| | | material criteria | material criteria | material criteria | material criteria |
| | | of the Japanese | of the Japanese | of the Japanese | of the Japanese |
| | | Building | Building | Building | Building |
| | | Standard Act | Standard Act | Standard Act | Standard Act |

TABLE 4

| | | Comparative | Comparative | Comparative | Comparative |
|---|---|---|---|---|---|
| | | Example 7 | Example 8 | Example 9 | Example 10 |
| Component | Resin 1 (parts by weight) | 100 | — | — | 100 |
| materials | Resin 2 (parts by weight) | — | 100 | — | — |
| | Resin 3 (parts by weight) | — | — | 100 | — |
| | Powdered flame retardant 1 (parts by weight) | — | — | 35 | — |
| | Powdered flame retardant 2 (parts by weight) | — | — | — | 6 |
| | Curing agent 1 (parts by weight) | 1 | — | 1 | 1 |
| | Curing agent 2 (parts by weight) | — | 1 | — | — |
| | Cure promoter (parts by weight) | 0.2 | — | 0.2 | 0.2 |
| | Stacking of fiber substrate 1 (no. of plies) | — | — | 4 | — |
| | Stacking of fiber substrate 2 (no. of plies) | 4 | 4 | — | 4 |
| | Core material | Core material 1 | Core material 1 | Core material 1 | Core material 1 |
| Flame | Total heat release (MJ/m²) | 10.1 | 12.3 | 8.0 | 10.7 |
| retardancy | Maximum heat release rate (kW/m²) | 202.1 | 292.3 | 356.3 | 233.8 |
| evaluation | Post-combustion state | resin burned, | resin burned, | resin burned, | resin burned, |
| | | fiber fabric | fiber fabric | fiber fabric | fiber fabric |
| | | maintains shape | maintains shape | maintains shape | maintains shape |
| | Determination | — | — | — | — |

The sandwich panels of Examples 6 to 9 are shown to have a flame retardancy far superior to that in Comparative Examples 7 and 8, which lacked a powdered flame retardant. The sandwich panels of Examples 6 to 9 are also shown to meet the flame-retardant material criteria established in the Japanese Building Standard Law. As shown by a comparison of Example 6 with Example 8, the total heat release and maximum heat release rate were still held down in Example 8, which had a low amount of powdered flame retardant addition, and the effect due to distribution of the powdered flame retardant was thus expressed to a substantial degree. On the other hand, the flame retardancy is shown to be unsatisfactory for the sandwich panel of Comparative Example 9, which did not use a bromine-containing resin, and for the sandwich panel of Comparative Example 10, which did not use aluminum hydroxide.

### EXPLANATION ON NUMERALS

10 Fiber structure, 11 Molding tool, 12a First resin distribution sheet, 12b Second resin distribution sheet, 13a First release sheet, 13b Second release sheet, 14 Sealing film, 15 Sealant, 16 Vacuum pump, 17 Resin tank, 18 Resin introduction port, 19 Exhaust port, 21 Powdered flame retardant, 22 Bromine-containing resin, 31 Foam, 51 Adhesive, 52 Carbon fiber-reinforced composite material, 61 Cab, 61a Elevator panel, 62 Car door, 63 Car frame, 63a Diagonal strut, 64 Font panel, 65 Reinforcement

1. A method of producing a fiber-reinforced composite material, the method comprising:
impregnating a carbon fiber structure with a resin by using a pressure difference between a vacuum pressure and an atmospheric pressure, and
curing the resin,
wherein
said impregnating comprises impregnating a mixture of a bromine-comprising resin and a powdered flame retardant that comprises at least one component selected from the group consisting of aluminum hydroxide and magnesium hydroxide and has an average particle size of from 0.1 to 20 μm, into the carbon fiber structure that has a mode value for a size of carbon fiber surrounded individual openings of from 0.03 to 3 mm² and an opening area percentage of from 0.1 to 10% from a surface direction of the carbon fiber structure, to unevenly distribute the powdered flame retardant in a surface layer of the carbon fiber structure, and
a ratio of a volume occupied by the carbon fiber structure in the fiber-reinforced composite material is from 25 to 85% by volume.

2. (canceled)

3. The method according to claim 1, comprising:
stacking the carbon fiber structure on a release-treated molding tool to obtain a stacked carbon fiber structure;
stacking a release sheet and a resin distribution sheet in this order on the stacked carbon fiber structure to obtain a stack formed of the carbon fiber structure, the resin distribution sheet, and the release sheet;
covering the stack formed of the carbon fiber structure, the resin distribution sheet, and the release sheet, with a sealing film to isolate the stack from an outside atmosphere;
evacuating air within the sealing film;
introducing the mixture of the powdered flame retardant and the bromine-comprising resin into the sealing film through the release sheet and the resin distribution sheet to impregnate the carbon fiber structure with the mixture;
curing the bromine-comprising resin; and
peeling off the release sheet along with the resin distribution sheet.

4. The method according to claim 1, comprising:
disposing, on a release-treated molding tool, a structure provided by sandwiching both surface sides of a core material made of a foam between carbon fiber structures to obtain a disposed structure;
stacking a release sheet and a resin distribution sheet in this order on the disposed structure to obtain a stack formed of the disposed structure, the resin distribution sheet, and the release sheet;
covering the stack formed of the disposed structure, the resin distribution sheet, and the release sheet, with a sealing film to isolate the stack from an outside atmosphere;
evacuating air within the sealing film;
introducing the mixture of the powdered flame retardant and the bromine-comprising resin into the sealing film through the release sheet and the resin distribution sheet to impregnate the carbon fiber structures with the mixture;
curing the bromine-comprising resin; and
peeling off the release sheet along with the resin distribution sheet.

5. A fiber-reinforced composite material produced by the method according to any one of claims 1, 3 and 4.

6-9. (canceled)

10. The fiber-reinforced composite material according to claim 5, wherein the bromine-comprising resin is cured at room temperature.

11. The fiber-reinforced composite material according to claim 5, wherein the bromine-comprising resin comprises at least one component selected from the group consisting of a brominated unsaturated polyester resin and a brominated epoxy acrylate resin.

12. The fiber-reinforced composite material according to claim 5, wherein the powdered flame retardant further comprises at least one component selected from the group consisting of antimony trioxide and zinc borate.

13. An elevator component member, comprising the fiber-reinforced composite material according to claim 5.

14. An elevator car, comprising the fiber-reinforced composite material according to claim 5.
